(19) United States
(12) Patent Application Publication
(10) Pub. No.: US 2014/0062425 A1
(43) Pub. Date: Mar. 6, 2014

(54) SYSTEM AND METHOD FOR INTERFACING VARIABLE SPEED GENERATORS TO A POWER GRID

(71) Applicants: Cyrus David Harbourt, Roanoke, VA (US); Robert Gregory Wagoner, Roanoke, VA (US); Luis José Garcés Rivera, Niskayuna, NY (US)

(72) Inventors: Cyrus David Harbourt, Roanoke, VA (US); Robert Gregory Wagoner, Roanoke, VA (US); Luis José Garcés Rivera, Niskayuna, NY (US)

(73) Assignee: General Electric Company, Schenectady, NY (US)

(21) Appl. No.: 13/600,788

(22) Filed: Aug. 31, 2012

(51) Int. Cl. H02P 9/48

(52) U.S. Cl. 322/32

(57) ABSTRACT

The present subject matter is directed to systems and methods for interfacing variable speed generators to a power distribution grid. A plurality of doubly-fed induction generators (DFIG) are provided and coupled to a common shaft of a prime mover. Each of the plurality of DFIGs provides an electrical power output having an output frequency based on a rotational speed of the common shaft. A converter coupled to each DFIG provides variable excitation signals to its respective DFIG sufficient to adjust its output frequency to conform to a power grid frequency requirement.

### FIELD OF THE INVENTION

The present subject matter relates generally to the field of power generation systems, and more particularly to a system and method for interfacing variable speed generators to a power distribution grid.

### BACKGROUND OF THE INVENTION

Power generation systems generate electrical power from various sources, including hydropower, wind power, and from the combustion of fuels such as coal, oil and gas. These sources are harnessed to rotate prime movers, typically engines or turbines, that are coupled to power generators, which are in turn coupled to various loads via, for example, a power distribution grid (“grid”).

Power generation systems employ generators that generally produce electrical power that is proportional in frequency to the rotational speed of a turbine. Thus, changes in turbine speeds may result in changes to the frequency of power generated. Accordingly, the rotational speed of the turbine should be regulated to produce a frequency that matches the requirements of the grid. In situations where the turbine speed has been changed relative to the required speed, or is not sufficient to produce the required frequency, measures must be taken to modulate the generator output frequency to match the grid frequency.

A number of the prior art techniques have been proposed to compensate for changing turbine speeds. These techniques include controlling mechanical variables such as fuel flow rate to regulate turbine rotational speed and using multi-shaft configurations. In addition, various power conversion schemes have been used where power converters are coupled to the output of the generation system. Some utility scale variable speed generator systems require full power conversion, i.e., 100% of generated power goes through a power converter that connects the generator terminals to the grid. Full power conversion systems are limited in size because they require a converter with a rating at least equal to (but generally greater than) that of the generator so that it can handle fault currents without malfunctioning. In general, however, these techniques have proven to be either slow and/or inefficient.

Doubly-fed induction generators (DFIG) have been used in conjunction with wind turbines for reactive power control in response to fluctuations in wind speed. In addition, some wind turbine systems have been configured to use power converters to adjust their outputs to match the grid frequency. However, such reactive techniques do not provide a method for maintaining a selected output frequency during modifications to turbine speed (e.g., to increase efficiency), such as during turbine turn-down or modifications of turbine speed, e.g., in response to power demands.

It is known in the art to use a single DFIG system and to modulate the power output and frequency of such a power generation unit coupled to a power grid. Using such a DFIG system, the turbine speed can be modified without disturbing the generator output frequency. These DFIG systems couple a single DFIG with both a turbine and converter, such that the converter compensates for variations in the DFIG output frequency caused by changing turbines speeds by varying the excitation of the generator rotor to control the stator output frequency to match the grid frequency.

While single DFIG systems are effective at controlling output frequency, such systems generally can only provide up to about 3 megawatts of power, which is insufficient for operation at a utility scale, i.e., 100 to 500 megawatts. Single DFIG systems have limited power generation capacity due to manufacturing limitations with respect to the size and rating of machine components, particularly the DFIG shaft, rotor, and slip rings. Also, these single DFIG systems are difficult to implement due to the high rating of a full scale DFIG converter, which would necessarily be 10% to 20% of the generator rating. Finally, single DFIG systems do not provide for degraded mode operation, so the failure of one system component, e.g., a converter, shuts down the entire system.

In view of these known issues, it would be advantageous, therefore, to provide a system and method for controlling power output and frequency for a variable speed generator at a utility scale while reducing component size, rating, and stress.

### BRIEF DESCRIPTION OF THE INVENTION

Aspects and advantages of the subject matter will be set forth in part in the following description, or may be obvious from the description, or may be learned through practice of the subject matter.

The present subject matter relates to a system for interfacing plural variable speed generators to a power distribution grid. In exemplary embodiments, such system provides a prime mover configured to apply mechanical power from a power source to a shaft. In some embodiments, the power source may correspond to wind, water, or combustible fuels such as gas, coal or oil. In specific embodiments, a plurality of doubly-fed induction generators (DFIGs) are coupled to the shaft such that each of the plurality of DFIGs provide an electrical power output having an output frequency based at least in part on the rotational speed of the shaft. The system includes a plurality of converters coupled, respectively, to the plurality of DFIGs so that each of the plurality of converters provides excitation signals to its respective DFIG sufficient to adjust the output frequency thereof to conform to a power grid frequency requirement. In some embodiments, the power frequency requirement may correspond to a power distribution grid operating frequency of 50 Hz or 60 Hz.

In accordance with certain embodiments, each of the plurality of DFIGs comprises a stator and a rotor, with each stator configured to be coupled to the power distribution grid, and each rotor configured to be coupled to the power distribution grid through the converter. In some embodiments, a grid transformer may be provided to couple each stator to the power distribution grid. In other embodiments, each of the stators from the plurality of DFIGs share a common grid transformer, while in other embodiments, each stator is individually coupled to the grid via its own grid transformer.

In selected embodiments of the system, each rotor is configured to be coupled to the grid by way of a rotor transformer. In some embodiments, the rotor transformer is shared among the plurality of DFIGs, while in other embodiments, each DFIG is provided with its own rotor transformer.

In particular embodiments, the system also provides one or more speed sensors mounted on the shaft to provide signals indicative of the rotation speed of the shaft to control the operation of one or more of the DFIGs and the prime mover. In selected embodiments, a plurality of sensors are mounted on the shaft and the outputs thereof are configured so that they may share their speed signals among all of the DFIGs, or, in some embodiments, may apply their speed signals to the control of only a single DFIG or the prime mover.

The present subject matter also relates to methodology for interfacing plural variable speed generators to a power distribution grid. In accordance with such methodology, a plurality of doubly-fed induction generators (DFIGs) is coupled to be driven through a common shaft driven by a prime mover. Such method further provides that each of the plurality of DFIGs provides an electrical power output having an output frequency based at least in part on a rotational speed of the shaft.

Further the method calls for coupling a plurality of converters, respectively, to the plurality of DFIGs so that the converters may apply excitation signals to their respective DFIG sufficient to adjust the output frequency thereof to conform to a power grid frequency requirement. Finally, the method calls for coupling electrical power output from each of the plurality of DFIGs to a power distribution grid. In some embodiments, the method provides for coupling the electrical power output from the DFIGs to the power distribution grid through a grid transformer.

Further, in selected embodiments, the method provides for mounting at least one speed sensor on the shaft and providing signals from the speed sensor indicative of the rotation speed of the shaft to control the operation of one or more of the DFIGs and the prime mover. In some embodiments, the method provides for mounting plural speed sensors on the shaft and sharing the speed signals produced therefrom among all of the DFIGs and prime mover or, alternately, providing individual signals from individual speed sensors of the plurality of speed sensors to individual ones of the DFIGs and prime mover.

These and other features, aspects and advantages of the present subject matter will become better understood with reference to the following description and appended claims. The accompanying drawings, which are incorporated in and constitute a part of this specification, illustrate embodiments of the subject matter and, together with the description, serve to explain the principles of the subject matter.

### BRIEF DESCRIPTION OF THE DRAWINGS

A full and enabling disclosure of the present subject matter, including the best mode thereof, directed to one of ordinary skill in the art is set forth in the specification, which makes reference to the appended figures, in which:

FIG. 1 depicts aspects of a first embodiment of the present subject matter by schematically illustrating an electric power generating system employing two DFIG machines coupled to a common shaft in accordance with the present subject matter;

FIG. 2 depicts exemplary placement of speed sensors for measuring shaft speed of the FIG. 1 embodiment;

FIG. 3 illustrates a first alternative embodiment of the system of FIG. 1 in accordance with the present subject matter;

FIG. 4 illustrates a second alternative embodiment of the system of FIG. 1 in accordance with the present subject matter;

FIG. 5 illustrates an alternative embodiment of the system of FIG. 4 in accordance with the present subject matter;

FIG. 6 illustrates a flow chart depicting an exemplary method for frequency modulation in accordance with the present subject matter; and

FIG. 7 illustrates a prior art system for electrical power generation including a single DFIG coupled to a power grid.

Repeat use of reference characters throughout the present specification and appended drawings is intended to represent same or analogous features or elements of the invention.

### DETAILED DESCRIPTION OF THE SUBJECT MATTER

As discussed in the Summary of the Subject Matter section, the present subject matter is particularly concerned with methods and apparatus for interfacing plural commonly driven generators to a power grid.

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

With initial reference to FIG. 7, there is illustrated a known system 700 for electrical power generation including a single DFIG 705 coupled to a power grid 748 by way of grid transformer 744. System 700 also includes a converter 710, and prime mover 715. Prime mover 715 is configured to drive the rotor 707 of DFIG 705 by way of shaft 720. Rotor bus 734 is coupled to converter 710 that, in turn, is coupled via rotor bus 736 and rotor bus transformer 742 to system bus 738. The stator 709 of DFIG 705 is coupled via stator bus 735 to the system bus 738. Converter 710 is an AC/AC converter that is controlled via means (not separately illustrated) to provide controlled excitation of rotor 707 of DFIG 705 to produce, as is well understood by those of ordinary skill in the art, appropriate voltage generation responses from stator 709 of DFIG 705 for ultimate application to grid 748.

Although this system allows for the use of a converter 710 with a lower rating, e.g., 10 to 20% of the generator rating, such a system is still capable of providing only about 3 MW. In addition to converter limitations, the doubly-fed generator 705 limits the power providing capability due to system component ratings, for example, the limits to the amount of current and voltage that can be passed through rotor mounted slip rings of DFIG 705.

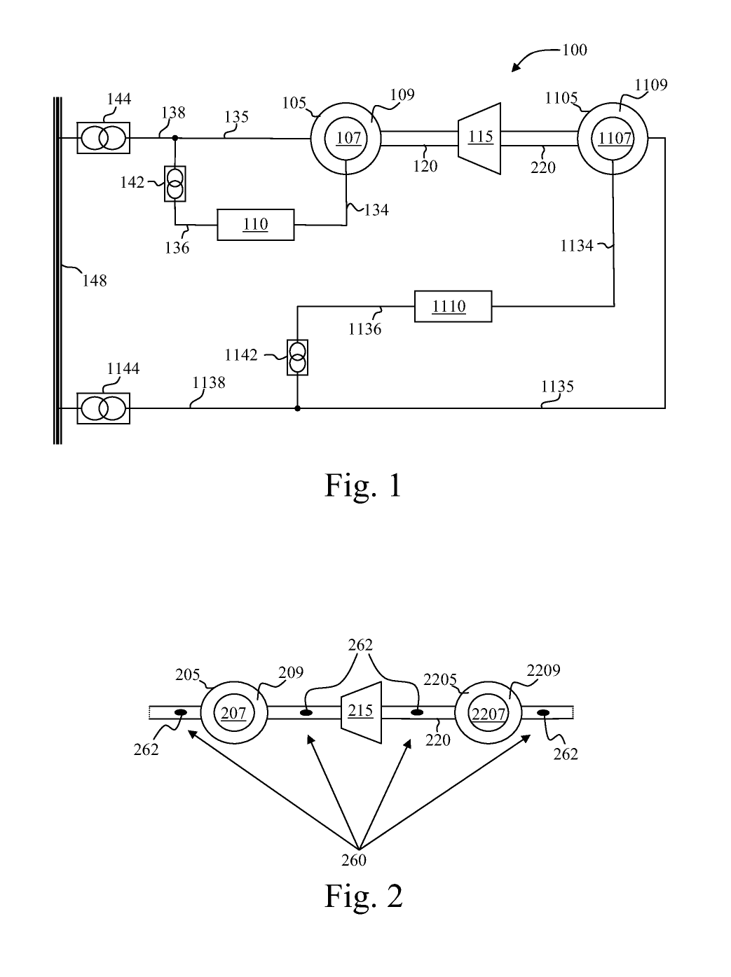

Referring now to FIG. 1, aspects of a first exemplary embodiment of the present subject matter is schematically illustrated as an electric power generating system 100 employing two doubly-fed induction generators (DFIG) 105, 1105 driven by a single prime mover 115 by way of a common shaft 120 in accordance with the present subject matter.

Those of ordinary skill in the art will appreciate that DFIGs 105, 1105 and prime mover 115 may alternately be coupled in any manner known now or in the future for coupling a power source and generator. For example, the presently illustrated common shaft 120 of prime mover 115 may be coupled directly to DFIGs 105, 1105 or may be coupled thereto through optional gear boxes. It should also be appreciated that while the presently presented embodiments of the present subject matter illustrate two DFIGs coupled to be driven by a single common shaft, the present subject matter is not intended to be so limited. Coupling any combination of such DFIGs to the same shaft is within the scope and spirit of the invention.

In certain embodiments, prime mover 115 may correspond to one or more hydroelectric and/or fuel combustion engines. For example, prime mover 115 may include one or more reciprocating engines and/or one or more rotating engines. In one exemplary embodiment, prime mover 115 may correspond to a wind turbine, a hydroelectric turbine, a gas turbine, a steam turbine, or any combination thereof. In another exemplary embodiment, prime mover 115 may correspond to at least one gas turbine coupled with at least one steam turbine, or at least one gas turbine coupled with a clutch that is in turn coupled with at least one steam turbine. A controller (not separately illustrated) may also be coupled to prime mover 115 to allow the rotational speed of prime mover 115 to be modified from, e.g., a full running speed or otherwise selected speed based on various conditions.

An aspect of certain embodiments of the present subject matter resides in the inclusion of operational redundancy such that the entire system does not shut down upon failure of a single system component. In this regard, it will be appreciated that each DFIG 105, 1105 includes a rotor 107, 1107 and a stator 109, 1109. Stator 109 of DFIG 105 is connected to power grid 148 by way of system bus 138 and grid transformer 144. Similarly, stator 1109 of DFIG 1105 is connected to power grid 148 by way of system bus 1138 and grid transformer 1144. The rotors 107, 1107 of each DFIG 105, 1105 are separately connected via individual converters 110, 1110, individual rotor buses 134, 1134, individual rotor transformers 142, 1142, and individual grid transformers 144, 1144 to grid 148. Converters 110, 1110 are both capable of independently generating rotor excitation signals for their respective DFIG rotor at frequencies varying from zero, i.e., direct current, to any desired frequency.

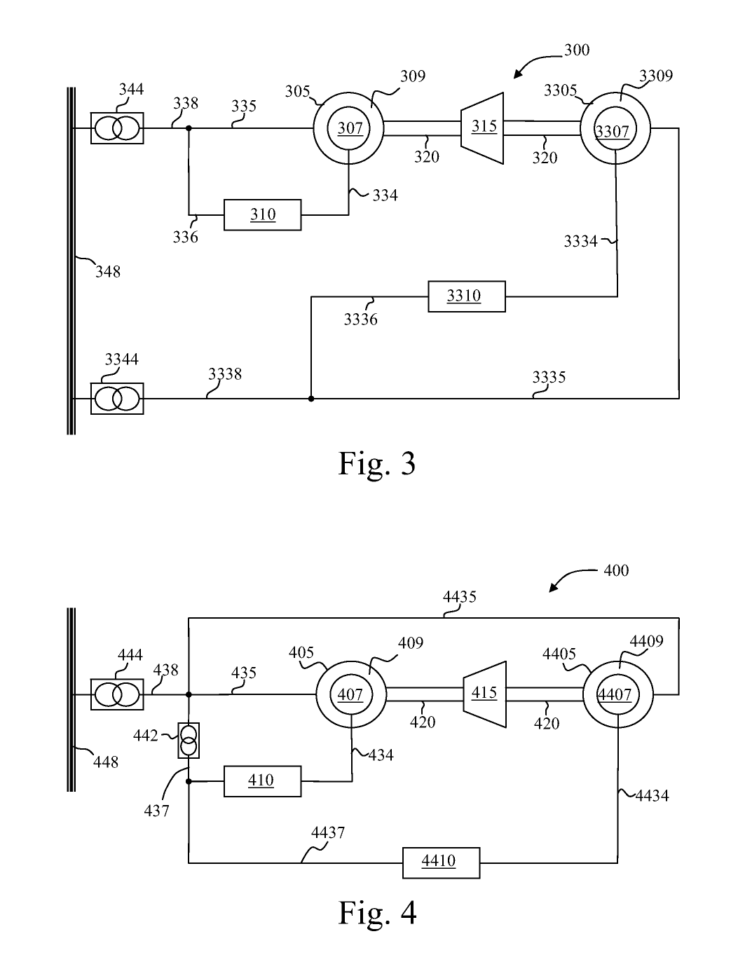

In accordance with this first embodiment of the present subject matter, each converter 110, 1110 is connected to their respective system bus 138, 1138 by a line bus 136, 1136 and line bus transformer 142, 1142. The line bus transformers 142, 1142 drop the system bus voltage such that converters 110, 1110 receive a lower potential thereby exposing the controllers to lower voltage levels. It should be appreciated, however, that other configurations are also anticipated where the line bus transformers 142, 1142 may be omitted, for example as illustrated in FIG. 3 discussed in greater detail below.

It should be noted that when reference is made herein to a “bus,” such may refer to any communication or transmission link that includes one or more conductors or lines that define or form an electrical, communication or other type of path. Further it should be appreciated that a bus may correspond to a multi-phase transmission link. In such regard, the buses described herein may transmit power in any number of phases (“N” phases) from the stators 109, 1109 and rotor buses 134, 1134 may provide “N” phase outputs to rotors 107, 1107. Further, although the presently preferred embodiments include three-phase configurations, the present subject matter is not so limited in that systems and methods constructed and performed in accordance with the present subject matter may include multi-phase configurations.

With further reference to FIG. 1, converters 110, 1110 may correspond to any type of AC/AC converter and may be configured for any mode of operation, as known by those of ordinary skill in the art. The input and output of each converter 110, 1110 may have any number and type of series and parallel filters. In exemplary embodiments, converters 110, 1110 are configured for three-phase, Pulse Width Modulation (PWM) operating.

Converters 110, 1110 may also include a controller (processor) configured, for example, to monitor the electrical output frequency from their respective DFIG 105, 1105. In various embodiments, converters 110, 1110 receive control signals, for example, based on sensed conditions or operating characteristics of the system 100. For example, control inputs and outputs may be based, without limitation, on information regarding the operation of prime mover 115, external information from remote locations, power grid 148 information, and other types of feedback.

With reference to FIG. 2, such exemplary feedback might include signals from speed sensor(s) 262 providing sensed speed of DFIGs 205, 2205 that may be used to control the conversion of the output power from stators 209, 2209 to maintain a proper and balanced power supply. In one embodiment, the controller may also be coupled to the prime mover 215 to allow the rotational speed of the common shaft 220 to be selected and modified as needed.

As illustrated in FIG. 2, one or more speed sensors 262 may be mounted on common shaft 220 of the prime mover 215. Speed sensors 262 provide feedback to the system regarding the rotational speed of the common shaft 220 and may be used by all system controllers to control the operation of DFIGs 205, 2205 or prime mover 215. For example, speed feedback information may be used by the controller associated with converter 110 (FIG. 1) to select an appropriate excitation signal frequency or by a controller associated with prime mover 215 (not separately illustrated) for controlling the rotational speed of common shaft 220.

In accordance with aspects of the present subject matter, each of the DFIGs 205, 2205 may have a shared or separate speed sensor 262. If one speed sensor 262 is used, it may be placed at either end of either DFIG 205 or DFIG 2205 and the speed feedback information may be shared by all system controllers. Such a configuration has the advantage of improving cost and reliability by utilizing only one speed sensor 262 instead of two. Alternatively, two speed sensors 262 may be used, with one placed at each end of the common shaft 220 to sense speed at both ends of the DFIG 205, 2205. Such a configuration has the advantage of allowing independent control of each generator/converter pair.

It should be appreciated that various combinations and locations of speed sensors 262 may be configured for a system including two DFIGs 205, 2205 on a common shaft 220, other than the preferred application of two speed sensors 262, one placed on each side of prime mover 215. The present subject matter is not limited to the use of one or two speed sensors 262, but includes the use of any number speed sensors 262, for providing feedback to one or more system components.

With reference again to FIG. 1, in operation, magnetic fields rotating through stator 109, 1109 produce current in windings (not separately illustrated) in stator 109, 1109. This current is output from DFIG 105, 1105 to grid 148 by way of grid transformer 144, 1144. The current and voltage produced by DFIG 105, 1105 is proportional in frequency to the rotational speed of the common shaft 120 of the prime mover 115.

In general, as understood by those of ordinary skill in the art, system 100 operates by synchronizing the output from the stator of DFIG 105, 1105 to the frequency of grid 148, i.e., by conforming to a grid frequency requirement. In some instances, DFIG 105, 1105 is synchronized to the grid 148 and will output a voltage and current at the grid frequency. However, this requires the prime mover 115 to also maintain its speed at the grid frequency. In instances where the prime mover 115 speed is not at the grid frequency, the system 100 compensates by feeding an excitation signal to DFIG 105, 1105 from controller 110, 1110 at a frequency designed to cause the stator 105, 1105 to output power at a frequency synchronized to grid 148.

In one embodiment, the stator bus 135, 1135, the line bus 136, 1136 and the rotor bus 134, 1134 form an excitation circuit through which the DFIGs 105, 1105 can be excited and/or the converter 110, 1110 can be powered. Current may be provided from the grid 148 and/or the stator 109, 1109 to the rotor 107, 1107 via the excitation circuit. If the current provided is DC current, the output of the stator 109, 1109 will be at a frequency proportional to the rotational speed of the common shaft 120. If the current provided to the rotor 107, 1107 has a frequency other than zero (DC), the frequency of the power output from the stator 109, 1109 may be modified relative to the output frequency based on a fed DC current. In this way, for example, the output frequency from the stator 109, 1109 may be maintained at the required frequency of the grid 148 (i.e., the “rated” frequency). Thus, by feeding the rotor 107, 1107 of the doubly-fed generator 105, 1105 with a given frequency of current other than DC, it appears to the doubly-fed generator 105, 1105 that the rotor 107, 1107 and the prime mover 115 are rotating at rated speed when in reality they are not.

The excitation circuit may also be used to provide power to the converter 110, 1110 from the stator 109, 1109 via the line bus 136, 1136. The input frequency is converted to the desired excitation frequency and is fed to the rotor 107, 1107, which causes the frequency of the output from the stator 109 to change accordingly. The excitation frequency may be continuously adjusted to produce a corresponding stator 109, 1109 output frequency.

The converter 110, 1110 may also be used for start-up purposes. In this embodiment, DFIG 105, 1105 components may be sized accordingly to be capable of operating as either a start-up means (using DFIG 105, 1105 as a motor) or as a rotor 107, 1107 frequency modulator.

For example, the generator 105, 1105 may be used to start prime mover 115 by driving DFIG 105, 1105 as a motor to accelerate prime mover 115 to a required start-up speed, after which the rotational speed of the common shaft 120 may be maintained using the appropriate fuel (e.g., gas, wind power, and hydropower).

To start prime mover 115, converter 110, 1110 may receive power from grid 148, and provide the voltage requirements to DFIGs 105, 1105, one or more of which is driven as a motor for accelerating prime mover 115 to start-up speed. In other embodiments, converters 110, 1110 may receive power from any desired source in addition to grid 148, such as a separate excitation generator (not separately illustrated). The controller may be used to control changes in frequency and voltage needed during the start-up phase to accelerate prime mover 115, or a turbine controller (not shown) or any other control device may be used.

It should be appreciated that individual ones of the generators 105, 1105 may be used independently of the other as a motor to start prime mover 115 while the other of the two generators is either unavailable or is used as a generator. Thereby providing further redundancy aspects for the present subject matter.

With reference now to FIG. 3, an alternate system embodiment 300 is illustrated. In this embodiment, system 300 includes a prime mover 315, two DFIGs 305, 3305 and two converters 310, 3310. However, this embodiment does not require a line bus transformer, such as line bus transformer 142 of FIG. 1, to step down the system bus 338, 3338 voltage. Instead, each converter 310, 3310 is connected directly to the system bus 338, 3338 through the line bus 336, 3336. Remaining components and buses in FIG. 3 carry labels corresponding to those of FIG. 1 except for the 3xx or 33xx designations instead of 1xx and 11xx of FIG. 1 but otherwise are equivalent items and will not be further described in the interest of avoiding unnecessary duplication of description.

With reference now to FIG. 4, there is illustrated a second alternative system embodiment 400. In accordance with this embodiment, system 400 includes a prime mover 415, two DFIGs 405, 4405 and two converters 410, 4410. In this alternate embodiment, however, the converters 410, 4410 are connected to system bus 438 by a shared line bus 437 and a shared line bus transformer 442. Remaining components and buses in FIG. 4 carry labels corresponding exactly to those of FIG. 3 except for the 4xx or 44xx designations instead of 3xx and 33xx of FIG. 3 but otherwise are equivalent items and will not be further described in the interest of avoiding unnecessary duplication of description.

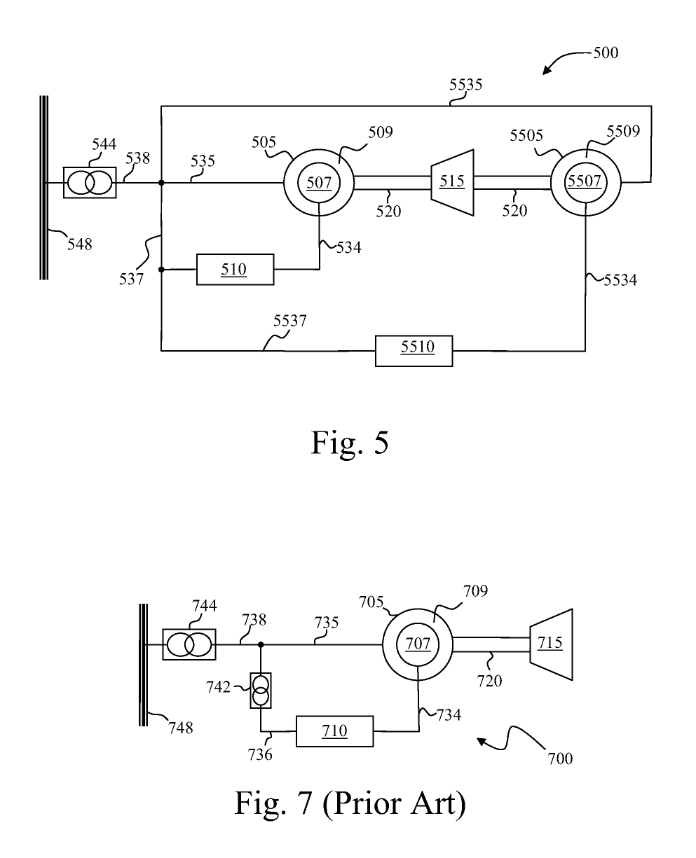

With reference now to FIG. 5, there is illustrated an alternative system embodiment 500 that is a variation of the embodiment of FIG. 4, except that this embodiment does not include a shared line bus transformer equivalent to bus transformer 442 of FIG. 4. Instead, the shared line bus 537 is connected directly to the system bus 538. The other components are essentially identical to that of FIG. 4 and carry equivalent labels except for 5xx and 55xx notation for equivalent lines and components 4xx and 44xx

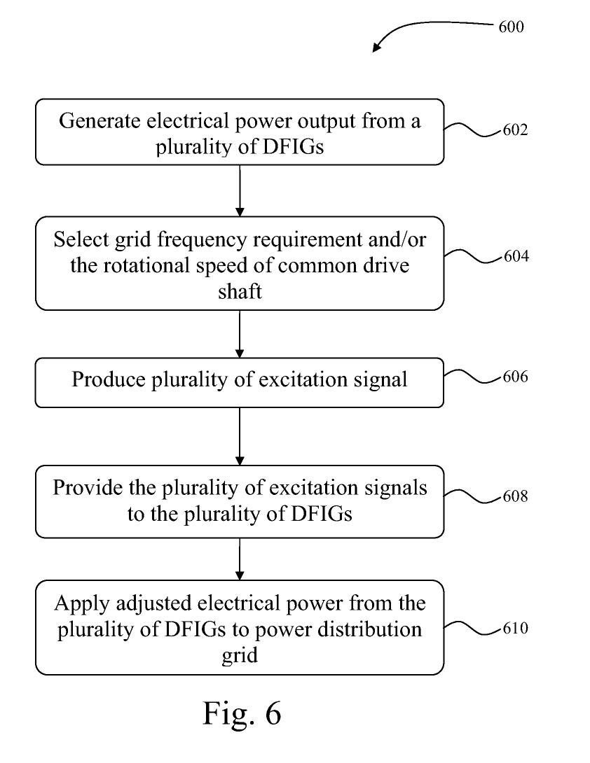

FIG. 6 illustrates a flow chart 600 depicting an exemplary method for automatic frequency modulation of doubly-fed induction generators so that such variable speed generators may be coupled to a power grid in accordance with the present subject matter. As illustrated in FIG. 6, method 600 includes several steps, all of which may be performed by execution of a control application associated with a power generator. For example, method 600 may be performed in conjunction with the power generation system 100 described herein above. Further, method 600 may be employed with any suitable type prime mover such as prime mover 115 of FIG. 1 and/or any suitable device for converting the frequency of electric power such as controllers 110, 1110 also illustrated in FIG. 1. It should be appreciated that although method 600 is discussed with respect to operation of power generation system 100 shown in FIG. 1 containing two DFIGs 105, 1105, the method may equally be employed for any system including two or more generators.

With further reference to FIG. 6, at step 602, each of plural (two or more) DFIGs generates electrical power having, among other characteristics, an output frequency. This electrical power output may be from the respective DFIG stators resulting from rotation of respective rotors, which corresponds to the rotation of a common shaft. As previously noted, the output frequency is dependent on rotational speed of the DFIG as defined by the rotor speed.

In some embodiments, the electrical power output of the DFIG is monitored, e.g., continuously or periodically, and may also be compared to the required grid frequency. In one embodiment, “grid frequency requirement” refers to the frequency required by the grid 148 (FIG. 1). The grid frequency requirement may be a single frequency, multiple frequencies, or a range of frequencies. Such monitoring and comparison may be performed, for example, by a controller coupled to the DFIG, or may be performed by any other controllers or computing devices. In an exemplary configuration, the required grid frequency may correspond to common grid frequencies of 50 or 60 Hertz. A significant aspect of the present methodology is that the same devices may be provided to provide power that may be coupled to various grids operating a various frequencies with minimal modification (changing selected transformers) of the basic system.

At step 604, the rotational speed of the common shaft is selected (e.g., modified from an operating speed), and/or a grid frequency requirement is selected or modified. s used herein, the term “operating speed” refers to a rotational speed of the common shaft that corresponds to a desired stator output frequency, such as the frequency required by the grid.

In one embodiment, selecting or modifying the grid frequency requirement may include changing the grid transformer appropriate for use with a first grid having a first grid frequency requirement to a transformer appropriate for use with a second grid having a second different grid frequency requirement.

Selection of the rotational speed may occur due to any number of reasons. In one embodiment, the rotational speed may be selected or modified to increase or optimize the efficiency of the overall system. For example, an issue facing power generation is the loss of efficiency during prime mover turn-down under certain configurations. In certain instances, for example when power demand is low, it is desirable to “turn down” the prime mover, i.e., reduce the rotational speed of the common shaft. In such instances (with reference to items in FIG. 1), the output of the converter 110 may be varied based on desired prime mover 115 speed, so that the prime mover 115 can be turned down, the frequency from the converter 110 can be ramped up, and the overall output frequency of DFIG 105 can be maintained at the same frequency, with a reduction in the power output as required by the grid 148. This would be applicable to times when less power is required (such as night). When the grid 148 again requires full output, the prime mover 115 can be ramped to rated (synchronous) speed to provide increased power as necessary and the converter 110 can be reduced to a DC output.

At step 606 of method 600, the converters produce a plurality of excitation signals and apply such to the plurality of DFIGs. These excitation signals should be of a value (frequency) sufficient to cause the DFIGs to produce a selected output frequency. In one embodiment, the selected frequency is a frequency having a value that conforms to the grid frequency requirement.

At step 608 of method 600, the converters provide the produced excitation signals to the rotors of the plurality of DFIGs to adjust their output frequency.

At step 610 of method 600, the plurality of DFIGs output power to the grid at the selected frequency.

A number of advantages and technical contributions accrue from the above-disclosed embodiments, some of which are discussed below. The systems and methods described herein allow the operation of a prime mover to be optimized based on the ability to turn down, that is, slow down the prime mover, while maintaining the grid frequency. For example, during periods of low power demand (e.g., nighttime), the prime mover may be turned down when peak power is not required. In the other hand, during higher demand conditions, power can be taken from the rotor as well as the stator of the DFIGs to maintain the output at the desired frequency. Such ability to vary the rotational speed of the prime mover while maintaining a constant, grid matched, operating frequency from the DFIGs enables operation at higher efficiencies.

An additional advantage of the present subject matter is that the present configuration allows the use of a single DFIG/prime mover system with electric grids operating at different frequencies. For example, a single wind turbine constructed in accordance with the present subject matter could provide power to either a 50 Hz or 60 Hz grid simply by changing the grid transformer and/or the line bus transformer. Furthermore, that wind turbine could be designed for peak efficiency at a non-synchronous speed, thus decoupling the turbine design from the grid frequency requirements.

A primary advantage of the systems and methods described herein is that multiple DFIG machine systems can operate at power levels that single DFIG systems cannot. This is important in applications where a single DFIG machine cannot be built to match the engine power output. While a single DFIG machine may have limitations and difficulties related to rotor stress and size and rating of rotor slip rings, combining a plurality of smaller DFIG machines will enable a system to be built that minimizes the rating of the rotor converters, and ensures that fault currents are not limited by overload rating of a full power converter attached to generator terminals.

A system including multiple DFIG machines coupled to a common shaft can achieve the same purpose as a single full-rated DFIG machine, but with components that are smaller in size and have lower ratings. For example, the DFIG rotor converter that may be much smaller than a full power conversion unit or matrix converter for the same generator rating. Finally, multiple DFIG units imply that full engine torque does not need to be transmitted through the DFIG shaft, as is the case for a single generator.

Other advantages that stem from the use of multiple DFIG machines include the use of redundant converters and degraded mode operation, such that the failure of one component, e.g., a converter, does not necessarily shut down the entire system.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A system for interfacing plural variable speed generators to a power distribution grid, comprising:
a prime mover configured to apply mechanical power from a power source to a shaft;
a plurality of doubly-fed induction generators (DFIGs) coupled to said shaft, each of said plurality of DFIGs providing an electrical power output having an output frequency based at least in part on a rotational speed of said shaft; and
a plurality of converters coupled, respectively, to said plurality of DFIGs, wherein each of said plurality of converters is configured to provide excitation signals to its respective DFIG sufficient to adjust the output frequency thereof to conform to a power grid frequency requirement.

2. A system as in claim 1, wherein each of said plurality of DFIGs comprises a stator and a rotor, wherein each stator is configured to be coupled to said power distribution grid, and wherein each rotor is configured to be coupled to said power distribution grid through said converter.

3. A system as in claim 2, further comprising:
a grid transformer configured to be coupled to said power distribution grid,
wherein each stator is configured to be coupled to said power distribution grid through said grid transformer.

4. A system as in claim 2, further comprising:
a plurality of grid transformers each configured to be coupled to said power distribution grid,
wherein each stator is configured to be coupled individually to said power distribution grid through one of said plurality of grid transformers.

5. A system as in claim 2, wherein each rotor is configured to be coupled to said grid by way of a rotor transformer.

6. A system as in claim 5, wherein each rotor is configured to be coupled to said grid by way of a common rotor transformer.

7. A system as in claim 5, wherein each rotor is configured to be coupled to said grid by way of an individual rotor transformer.

8. A system as in claim 1, further comprising:
at least one speed sensor mounted on said shaft, wherein said at least one sensor is configured to provide signals indicative of the rotation speed of said shaft to control the operation of one or more of said DFIGs and said prime mover.

9. A system as in claim 8, wherein a plurality of sensors is mounted on said shaft.

10. A system as in claim 9, wherein at least one of said plurality of sensors is configured to provide shaft rotational speed signals to individually ones of said DFIGs.

11. A system as in claim 1, wherein said power source comprises one of wind, water, and combustible fuels.

12. A system as in claim 1, wherein said power grid frequency requirement corresponds to an operating frequency of one of 50 Hz and 60 Hz.

13. A method for interfacing plural variable speed generators to a power distribution grid, comprising:
coupling a plurality of doubly-fed induction generators (DFIGs) to be driven through a shaft driven by a prime mover, each of said plurality of DFIGs providing an electrical power output having an output frequency based at least in part on a rotational speed of said shaft;
coupling a plurality of converters, respectively, to said plurality of DFIGs;
applying excitation signals from of said plurality of converters to its respective DFIG sufficient to adjust the output frequency thereof to conform to a power grid frequency requirement; and
coupling the electrical power output from each of said plurality of DFIGs to a power distribution grid.

14. A method as in claim 13, wherein each of said plurality of DFIGs comprises a stator and a rotor, wherein coupling the electrical power output from each of said plurality of DFIGs to a power distribution grid comprises coupling each stator to said power distribution grid, and further comprising:
coupling each rotor to said power distribution grid through said converter.

15. A method as in claim 14, further comprising:
coupling each stator to said power distribution grid through a grid transformer.

16. A system as in claim 14, further comprising:
coupling each stator individually through a grid transformer to said power distribution grid.

17. A method as in claim 14, further comprising:
coupling each rotor to said grid by way of a rotor transformer.

18. A system as in claim 14, further comprising:
coupling each rotor to said grid by way of a common rotor transformer.

19. A method as in claim 13, further comprising:
mounting at least one speed sensor on said shaft; and
providing signals from said at least one speed sensor indicative of the rotation speed of said shaft to control the operation of one or more of said DFIGs and said prime mover.

20. A method as in claim 13, further comprising:
mounting a plurality of speed sensors on said shaft; and
providing signals from said plurality of speed sensor indicative of the rotation speed of said shaft to control the operation of one or more of said DFIGs and said prime mover.
